(19) United States
(12) Patent Application Publication
(10) Pub. No.: US 2026/0307797 A1
(43) Pub. Date: Oct. 8, 2026

(54) Galley With Electronic Display

(71) Applicant: B/E Aerospace, Inc., Winston Salem, NC (US)

(72) Inventors: Kyle Nathen Swen, Crystal Lake, IL (US); Travis John Vaninetti, Bothell, WA (US); Jefferey M. McKee, Duvall, WA (US)

(73) Assignee: B/E Aerospace, Inc., Winston Salem, NC (US)

(21) Appl. No.: 19/637,758

(22) Filed: Apr. 2, 2026

Related U.S. Application Data
(60) Provisional application No. 63/783,853, filed on Apr. 4, 2025.

(51) Int. Cl. B64D 11/04; F16M 11/04; F16M 11/08

(52) U.S. Cl. CPC B64D 11/04; F16M 11/041; F16M 11/08

(57) ABSTRACT

An aircraft galley may include an integrated electronic display mounted to a retention assembly of the aircraft galley in an unintrusive manner. The electronic display may be selectively mounted to the retention assembly. The electronic display may be stowable within the retention assembly. The electronic display may have an atypically shaped display face and perimeter. The retention assembly may retain the electronic display during aircraft operations. The retention assembly may include retention cords, pivoting latches, clamps coupled to an adjustable bar, rotatable clasps, or magnetic retention elements. The electronic display may be selectively detachable from the galley structure. In various embodiments, the electronic display is stowable within the retention assembly, deployable through a slot, rotatable between one or more deployed positions. The electronic display may be a projector configured to project an image onto a galley surface.

### CROSS REFERENCE TO RELATED APPLICATIONS

This application claims the benefit of and priority to U.S. Provisional Application No. 63/783,853, entitled “GALLEY WITH ELECTRONIC DISPLAY,” filed on Apr. 4, 2025, which is hereby incorporated by reference in its entirety for all purposes.

### TECHNICAL FIELD

The present disclosure relates generally to electronic displays and, more particularly, to electronic displays for aircraft galleys.

### BACKGROUND

Aircraft galleys may be small, busy spaces. Maintaining and organizing aircraft galleys entails extensive attention from aircraft crew. Air crew may be performing multiple tasks in a contained space and may need access to various surfaces and compartments. As technology provides for increased monitoring and maintenance of various factors such as, but not limited to, flight status, open tasks, equipment status, maintenance status, etc., information consolidation and availability may be desired. Conventional methods may include obstructing surfaces or compartments that may otherwise be useful for equipment or task performance. Conventional methods may include distributed information in various locations. Conventional methods may include solutions that also impede workflow or increase crowding in galley areas.

### SUMMARY

An aircraft galley is disclosed. The aircraft galley may comprise a retention assembly; and
an electronic display having a display housing and a display face. In various embodiments, the electronic display may be mounted to the retention assembly in an unintrusive manner. In various embodiments, the retention assembly may be configured to retain the electronic display during aircraft operations.

In various embodiments, the electronic display may have at least one of a triangular shape or an irregular polygon shape.

In various embodiments, the electronic display may be fixedly mounted to the retention assembly proximate a storage compartment. In various embodiments, an area of the display face may be less than an area of the storage compartment.

In various embodiments, the electronic display may be selectively mounted to the retention assembly.

In various embodiments, the electronic display may be selectively mounted to the retention assembly via at least one of retention cords having end fittings configured to releasably attach to anchors coupled to the retention assembly, or pivoting latches each having a catch portion configured to selectively engage the electronic display.

In various embodiments, the electronic display may be selectively mounted to the retention assembly via at least one clamp having a device-receiving region configured to grip a peripheral edge of the electronic display.

In various embodiments, the at least one clamp may be coupled to an adjustable bar.

In various embodiments, the at least one clamp may be one of a pair of clamps coupled to opposing ends of the adjustable bar such that the pair of clamps is biased toward each other to retain the display housing therebetween.

In various embodiments, the electronic display may be selectively mounted to the retention assembly via a clasp having a clasp body and a pivot member. In various embodiments, the pivot member may be fixedly coupled to the retention assembly and the clasp body.

In various embodiments, the electronic display may be selectively mounted to the retention assembly via magnetic retention comprising a first magnet disposed within the electronic display and at least one of a second magnet or a ferromagnetic element disposed within the retention assembly. In various embodiments, the first magnet and the at least one of the second magnet or the ferromagnetic element may be configured to magnetically couple and retain the electronic display to the retention assembly during aircraft operations.

An aircraft galley is disclosed. The aircraft galley may comprise a retention assembly at least partially defining a frame of a galley feature; and an electronic display mounted to the retention assembly in an unintrusive manner such that the electronic display does not obstruct or impede access to galley features of the aircraft galley. In various embodiments, the retention assembly may be distinct from conventional galley features and is configured specifically to support and retain the electronic display.

In various embodiments, the electronic display may be configured to display at least one of a flight status, a task status, an equipment status, a maintenance status, an emergency procedure, or an inventory status on a display face of the electronic display.

In various embodiments, the retention assembly may comprise a slot.

In various embodiments, the aircraft galley may further comprise a hinge coupling the electronic display to the retention assembly. In various embodiments, the electronic display and the hinge may be stowable within an opening of the retention assembly. In various embodiments, the opening may be at least partially defined by the slot. In various embodiments, the electronic display may be configured to translate from the slot in a first direction to a first deployed position.

In various embodiments, in response to translating the electronic display to the first deployed position, the hinge may at least partially extend from the slot such that the electronic display is rotatable about the hinge to a second deployed position.

An aircraft galley is disclosed. The aircraft galley may comprise a retention assembly at least partially defining a frame of a galley feature; and an electronic display stowable within the retention assembly in an unintrusive manner, wherein the retention assembly defines a stowage cavity or a slot configured to receive and conceal the electronic display when in a stowed position such that a surface of the retention assembly remains substantially flush and unobstructed.

In various embodiments, the retention assembly may comprise the slot.

In various embodiments, the aircraft galley may further comprise a hinge coupling the electronic display to the retention assembly. In various embodiments, the electronic display and the hinge may be stowable within an opening of the retention assembly. In various embodiments, the opening may be at least partially defined by the slot. In various embodiments, in response to translating the electronic display from the stowed position to a first deployed position, the hinge may at least partially extend from the slot such that the electronic display is rotatable about the hinge to a second deployed position.

In various embodiments, the retention assembly may comprise a counter area. In various embodiments, a top surface of the electronic display may be configured to be disposed flush with the counter area in a stowed position.

In various embodiments, the electronic display may be a projector.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A illustrates a front view of an aircraft galley, in accordance with various embodiments;

FIG. 1B illustrates a perspective view of an aircraft galley, in accordance with various embodiments;

FIG. 2A illustrates a front view of an electronic display, in accordance with various embodiments;

FIG. 2B illustrates a perspective view of an electronic display, in accordance with various embodiments;

FIG. 3 illustrates an electronic display, in accordance with various embodiments;

FIG. 4 illustrates an electronic display, in accordance with various embodiments;

FIG. 5A illustrates an electronic display extending from an aircraft galley, in accordance with various embodiments;

FIG. 5B illustrates the electronic display of FIG. 5A in an extended position, in accordance with various embodiments;

FIG. 6A illustrates an electronic display in a projection configuration, in accordance with various embodiments;

FIG. 6B illustrates the electronic display of FIG. 6A in a stowed position, in accordance with various embodiments;

FIG. 7 illustrates retention cords for an electronic display, in accordance with various embodiments;

FIG. 8 illustrates pivoting latches for an electronic display, in accordance with various embodiments;

FIG. 9 illustrates a clamp for an electronic display, in accordance with various embodiments;

FIG. 10 illustrates clasps for an electronic display, in accordance with various embodiments;

FIG. 11 illustrates retention magnets for an electronic display, in accordance with various embodiments;

FIG. 12 illustrates an electronic display in an extended position, in accordance with various embodiments; and

FIG. 13 illustrates an electronic display in an extended position, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion.

Disclosed herein are electronic displays, including, for example, installed screens, electronic tablet devices, and/or hand-held electronic devices, for aircraft galleys. The electronic displays of the present disclosure may be disposed approximately eye-level (i.e. between three feet and seven feet, between four feet and six feet, or approximately five feet high) for accessibility to crew members working in and around the galley. The electronic displays of the present disclosure may provide utility to the crew based around specific needs of the carrier and destination. The electronic displays of the present disclosure may provide detailed order information, communications, operations, or other static or dynamic content including, for example, flight status, task status, equipment status, maintenance status, emergency procedures, inventory status, etc. The electronic displays of the present disclosure may cycle through various dashboards, display information continuously, or display information in response to a demand request or change in status. The electronic displays of the present disclosure may enhance crew collaboration and productivity by allowing easy access to flight data and service requirements. Streamlined flight and cabin operations may reduce stress for flight attendants and may ensure more efficient meal and beverage services. Accordingly, the electronic displays of the present disclosure may reduce delays caused by miscommunication or lack of access to crucial information. The electronic displays of the present disclosure may result in reduced operational overhead by improving resource management (meal inventories, catering coordination).

Further, the electronic displays of the present disclosure may be incorporated into aircraft galleys while maintaining counter space and storage space within the aircraft galley. The electronic displays of the present disclosure may be disposed in an unintrusive area without obstructing access to otherwise busy or utility-saturated areas of the galley space. The electronic displays of the present disclosure may be disposed in spaces that are traditionally difficult to utilize in the fore or aft complexes of both single-aisle and twin-aisle commercial aircraft. The electronic displays of the present disclosure may be dimensioned to fit within an angled space or be an alternative shape, as disclosed further herein.

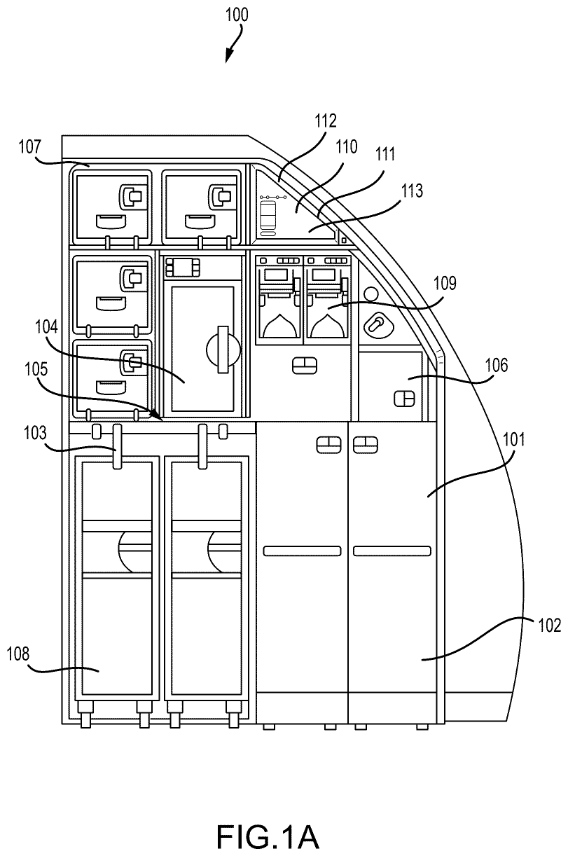

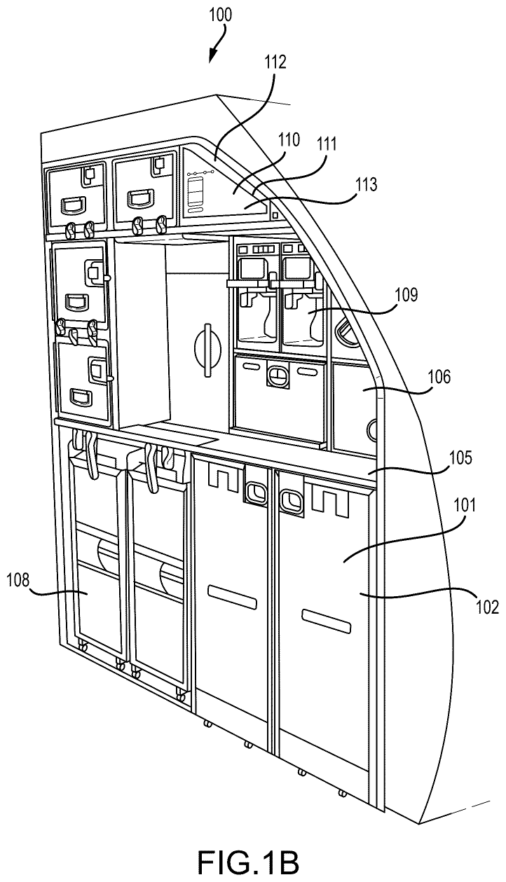

With reference to FIGS. 1A and 1B, an aircraft galley 100 is illustrated. In various embodiments, aircraft galley 100 may comprise a plurality of galley features. The galley features may include doors 101, chillers 102, latches 103, ovens 104, counter areas 105, bins 106, storage compartments 107, carts 108, coffee pots 109, or any other object found in an aircraft galley. The galley features may include one or more electronic displays 110.

In various embodiments, electronic display 110 comprises a display housing 111 containing a display face 113. The display face 113 may be an integrated screen. In various embodiments, display face 113 may be a touch-capable screen. In various embodiments, display face 113 may not be touch-capable. In various embodiments, electronic display 110 may be installed into aircraft galley 100 by installing and/or mounting display housing 111 to various structures and/or various galley features of aircraft galley 100. In various embodiments, electronic display 110 may be detachable from aircraft galley 100 as a portable electronic device (for example, a portable tablet). In various embodiments, electronic display 110 may be a projection onto aircraft galley 100. In various embodiments, electronic display 110 may be a tablet mountable to aircraft galley 100.

In various embodiments, electronic display 110 may comprise various screen configurations such as a flight status dashboard, a task list, timers, chiller states, oven states, maintenance status and/or alerts, catering load sheets, emergency procedures, inventory status, etc. In various embodiments, electronic display 110 may have various lighting modes such as daytime lighting, bright, nighttime lighting, dim, etc.

In various embodiments, the electronic display 110 is coupled to a retention assembly 112 of the aircraft galley 100 in an unintrusive manner. The retention assembly 112 is a mounting structure distinct from conventional galley features and configured specifically to support and retain the electronic display 110 without interfering with the primary functions of other galley components. The unintrusive manner may include mounting the electronic display 110 to a retention assembly 112 disposed in an area of the aircraft galley 100 that is unavailable to, unsuitable for, or otherwise unoccupied by other galley features. For example, the area may be an area that is geometrically incompatible with conventional galley features such as doors 101, chillers 102, latches 103, ovens 104, counter areas 105, bins 106, storage compartments 107, carts 108, coffee pots 109, etc., due to size, shape, or accessibility constraints. The unintrusive manner may include mounting the electronic display 110 to a retention assembly 112 disposed on a frame 117 of aircraft galley 100 such that the electronic display 110 does not obstruct, impede access to, or reduce the functionality of other galley features. For example, the retention assembly 112 may be positioned in a region that does not obstruct conventional galley features such as doors 101, chillers 102, latches 103, ovens 104, counter areas 105, bins 106, storage compartments 107, carts 108, coffee pots 109, etc., thereby preserving operational access to galley components during flight. The unintrusive manner may include selectively mounting the electronic display 110 such that the electronic display 110 is removable from the aircraft galley 100 in order to access various galley features. For example, the electronic display 110 may be selectively mounted via a quick-release mechanism, tool-free attachment, or releasable coupling such that the electronic display 110 may be removed to access conventional galley features such as doors 101, chillers 102, latches 103, ovens 104, counter areas 105, bins 106, storage compartments 107, carts 108, coffee pots 109, etc. The retention assembly 112 may be configured to withstand vibration, turbulence, and operational forces encountered during aircraft operations while maintaining the electronic display 110 in a stable, viewable orientation.

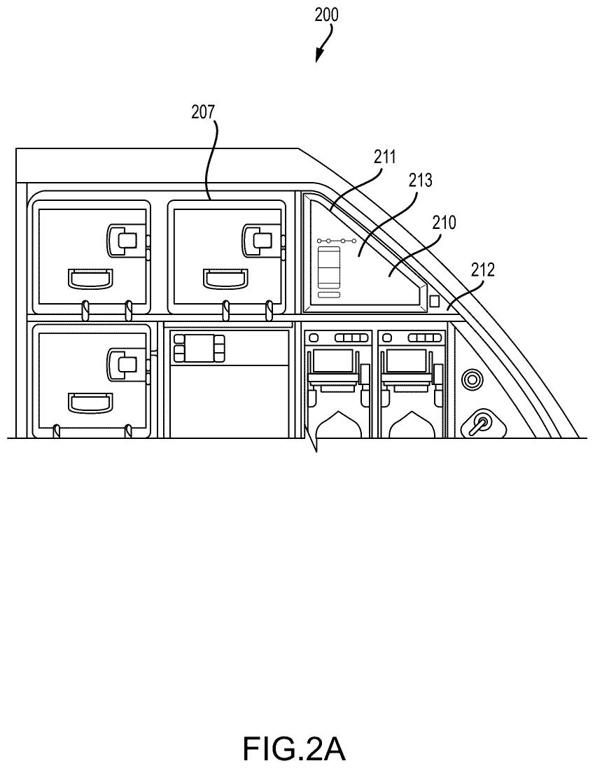

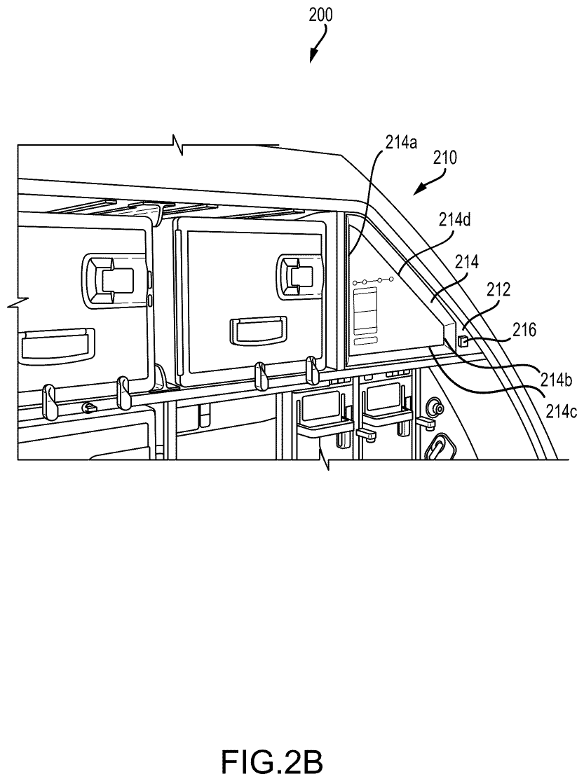

With reference to FIGS. 2A and 2B, an electronic display 210 is illustrated in a portion of an aircraft galley 200. Aircraft galley 200 may be similar to aircraft galley 100 such that like numbering represents like features. Electronic display 210 may be similar to electronic display 110 such that like numbering represents like features. In various embodiments, electronic display 210 is mounted to (or within) a retention assembly 212. Retention assembly 212 may have a mounting surface such as a galley panel or a surface of a galley feature such as a bin panel, a door panel, etc. In various embodiments, electronic display 210 is temporarily mounted to and detachable from retention assembly 212. Retention assembly 212 may have a frame 217 of an atypical shape. For example, retention assembly 212 may be a corner surface having a smaller area than storage compartment 207. As such, retention assembly 212 may not have a large enough area to comprise a storage compartment 207. In various embodiments, retention assembly 212 may be a triangular surface. In various embodiments, retention assembly 212 may be an irregular polygon surface. In various embodiments, retention assembly 212 may be truncated by a curvature of aircraft galley 200.

In various embodiments, electronic display 210 may be recessed into retention assembly 212. In various embodiments, electronic display 210 may have a perimeter 214. Perimeter 214 may be beveled. Perimeter 214 may be triangular. Perimeter 214 may be an irregular polygon. For example, perimeter 214 may have a first side 214a and a second side 214b parallel to first side 214a. Second side 214b may be substantially shorter than first side 214a (or vice versa). Perimeter 214 may have a third side 214c perpendicular to each of and coupling first side 214a and second side 214b. Perimeter 214 may have a fourth side 214d coupling first side 214a and second side 214b. Fourth side 214d may be oblique with respect to third side 214c. Fourth side 214d may intersect first side 214a (or second side 214b) at an acute angle and intersect second side 214b at an obtuse angle. Conversely and in various embodiments, fourth side 214d may intersect second side 214b at an acute angle and intersect first side 214a at an obtuse angle.

In various embodiments, aircraft galley 200 may have a control switch 216 for controlling electronic display 210. Control switch 216 may be an on/off switch. Control switch 216 may be a manual switch, a button, or any other form of selector. In various embodiments, control switch 216 is configured to select a mode of electronic display 210. In various embodiments, control switch 216 is configured to select a screen configuration of electronic display 210.

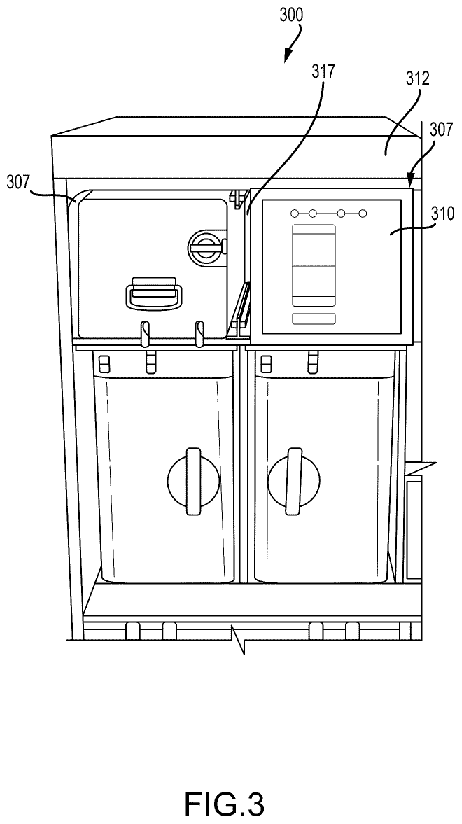

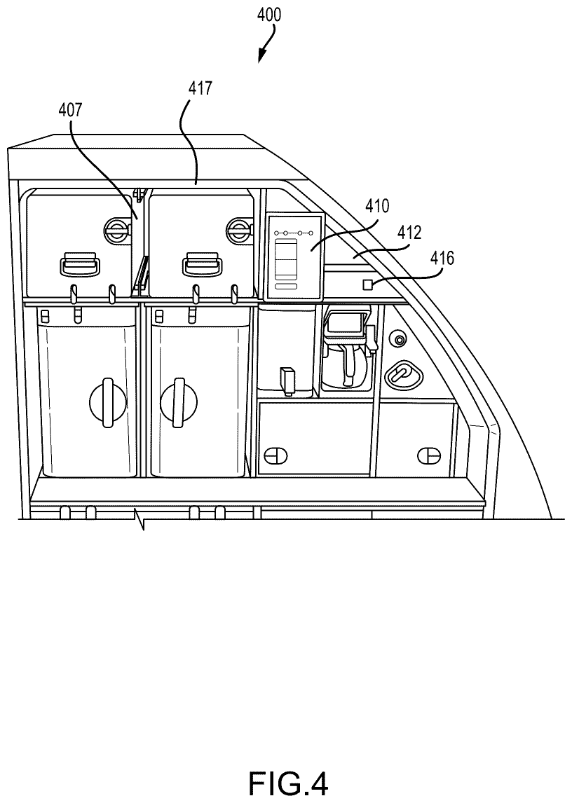

With reference to FIG. 3, an electronic display 310 is illustrated in a portion of an aircraft galley 300. Aircraft galley 300 may be similar to aircraft galley 100 such that like numbering represents like features. Electronic display 310 may be similar to electronic display 110 such that like numbering represents like features. In various embodiments, electronic display 310 is mountable to aircraft galley 300 via various means as described herein with respect to FIGS. 4-11. In various embodiments, electronic display 310 is mountable to a frame 317 of aircraft galley 300, such as a frame 317 of a storage compartment 307. Frame 317 may be a rigid body of aircraft galley 300 such as a galley panel, trim, door frames, or other rigid structures. In various embodiments, electronic display 310 is mountable to a retention assembly 312 of aircraft galley 300. Retention assembly 312 may be a galley panel or a surface of a galley feature such as a bin panel, a door panel, etc. In various embodiments, electronic display 310 is a square or rectangular shape. However, it should be understood that the disclosure is not limited in this regard. Electronic display 310 may be triangular, of an irregular polygon shape, or of any other suitable shape.

With reference to FIG. 4, an electronic display 410 is illustrated in a portion of an aircraft galley 400. Aircraft galley 400 may be similar to aircraft galley 100 such that like numbering represents like features. Electronic display 410 may be similar to electronic display 110 such that like numbering represents like features. In various embodiments, electronic display 410 is a portable tablet. In various embodiments, electronic display 410 is a square or rectangular shape. However, it should be understood that the disclosure is not limited in this regard. Electronic display 410 may be triangular, an irregular polygon shape, or of any other suitable shape. In various embodiments, electronic display 410 is selectively attachable to aircraft galley 400, as described further herein. In various embodiments, electronic display 410 is selectively attachable to a frame 417 of a storage compartment 407. In various embodiments, electronic display 410 is selectively attachable to a retention assembly 412.

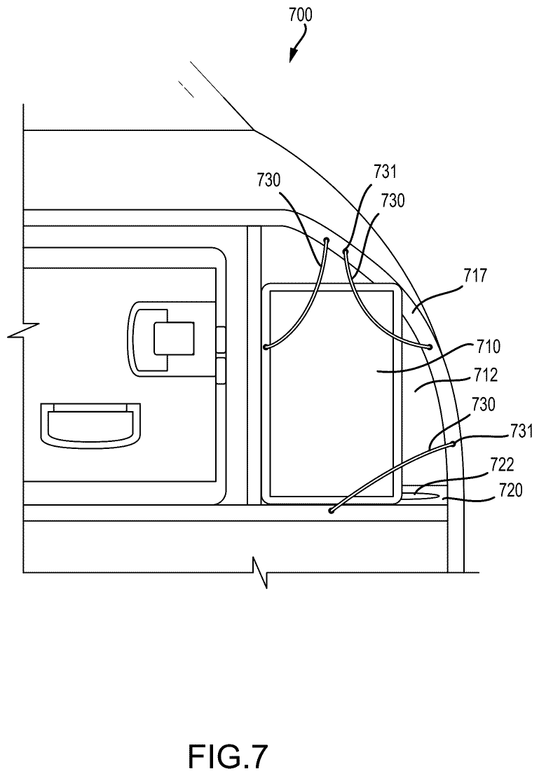

With additional reference to FIG. 7, an electronic display 710 is illustrated in a portion of an aircraft galley 700. Aircraft galley 700 may be similar to aircraft galley 400 such that like numbering represents like features. Electronic display 710 may be similar to electronic display 410 such that like numbering represents like features. Electronic display 710 may be secured to a frame 717 of aircraft galley 700. In various embodiments, electronic display 710 may be secured to a frame 717 of retention assembly 712. Electronic display 710 may be secured to frame 717 via one or more retention cords 730. Retention cords 730 may be resilient tethers comprising an elastic material, an elastic cord, a stretchable polymer, or other flexible elongate member capable of maintaining tension under varying loads. Retention cords 730 may terminate in end fittings, such as hooks, clips, carabiners, snap-hooks, loops, knots, crimped ferrules, toggle fasteners, or other coupling structures configured to releasably attach to corresponding anchors 731 of frame 717. The end fittings may be configured for single-handed operation by a crew member. Retention cords 730 and/or anchors 731 may be selectively attachable to frame 717 and may be stowable, retractable, or otherwise concealable so as not to obstruct aircraft galley 700 or interfere with crew workflow when electronic display 710 is not in use. In various embodiments, retention cords 730 are configured to apply a biasing force against electronic display 710 to maintain the electronic display 710 in contact with frame 717 during aircraft operations including takeoff, landing, and turbulence.

In various embodiments, frame 717 may include a ledge 720. Ledge 720 may have a recess 722 for receiving a bottom edge of electronic display 710. Ledge 720 and recess 722 may cooperate with retention cords 730 to stabilize electronic display 710 during flight operations, including during takeoff, landing, turbulence, and maneuvering, thereby preventing displacement, rattling, or damage to the electronic display 710. The combination of ledge 720, recess 722, and retention cords 730 provides a redundant retention system configured to secure the electronic display 710 against multi-directional forces.

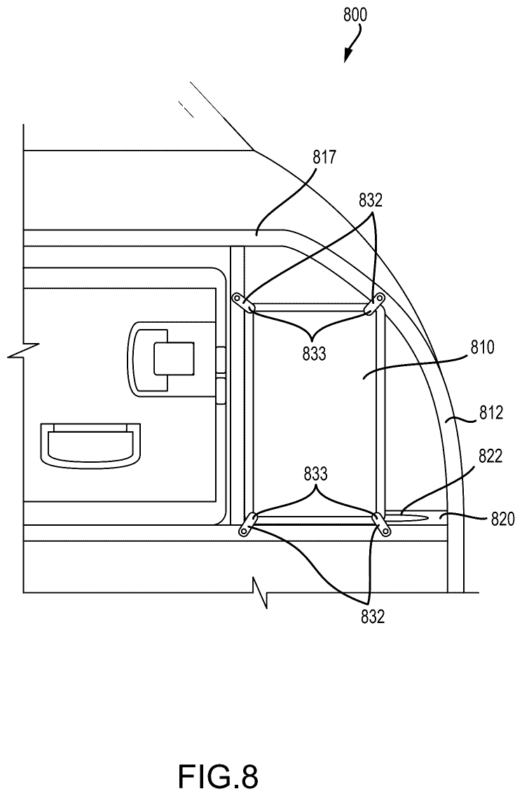

With additional reference to FIG. 8, an electronic display 810 is illustrated in a portion of an aircraft galley 800. Aircraft galley 800 may be similar to aircraft galley 400 such that like numbering represents like features. Electronic display 810 may be similar to electronic display 410 such that like numbering represents like features. Electronic display 810 may be secured to a frame 817 of aircraft galley 800. In various embodiments, electronic display 810 may be secured to a frame 817 of retention assembly 812. Electronic display 810 may be secured to frame 817 via one or more pivoting latches 832. Each pivoting latch 832 may have a body rotatably mounted to frame 817 about a latch axis. Each pivoting latch 832 may include a graspable portion configured for single-handed operation and a catch portion 833 having a hook, tooth, shoulder, cam surface, or retaining lip configured to selectively engage a peripheral surface, edge, or detent of electronic display 810. In an engaged state, catch portion 833 bears against electronic display 810 to resist separation of electronic display 810 from frame 817 under forces encountered during aircraft operations. In a disengaged state, pivoting latch 832 is rotated such that catch portion 833 clears electronic display 810 and permits movement of electronic display 810 from frame 817. Each pivoting latch 832 may be rotatable to a stowed position aligned with or recessed into frame 817 so as not to protrude into aircraft galley 800 or interfere with crew activities when electronic display 810 is not in use. In various embodiments, pivoting latches 832 may include a retention feature such as a detent, over-center spring, friction element, or positive lock configured to maintain the pivoting latch 832 in either the engaged state or the stowed position.

In various embodiments, frame 817 may include a ledge 820. Ledge 820 may have a recess 822 for receiving a bottom edge of electronic display 810. Ledge 820 and recess 822 may cooperate with pivoting latches 832 to stabilize electronic display 810 during flight operations, including during takeoff, landing, turbulence, and maneuvering, thereby preventing or mitigating displacement, rattling, or damage to the electronic display 810. The combination of ledge 820, recess 822, and pivoting latches 832 provides a redundant retention system configured to secure the electronic display 810 against multi-directional forces encountered during aircraft operations.

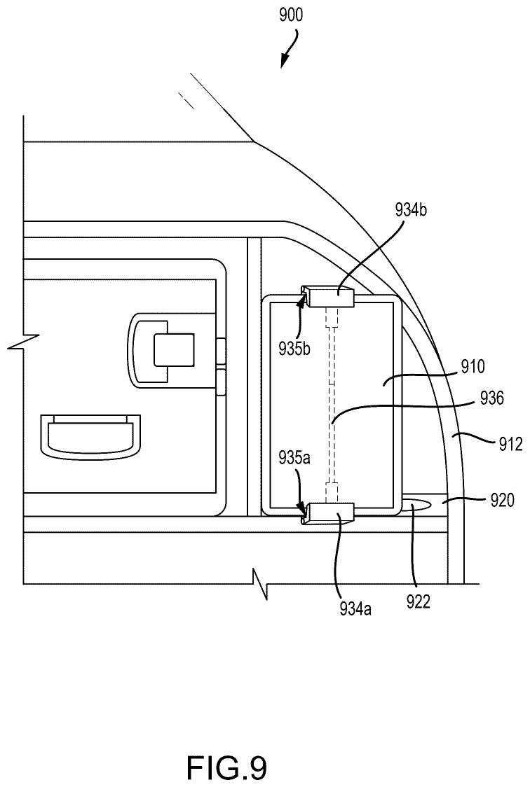

With additional reference to FIG. 9, an electronic display 910 is illustrated in a portion of an aircraft galley 900. Aircraft galley 900 may be similar to aircraft galley 400 such that like numbering represents like features. Electronic display 910 may be similar to electronic display 410 such that like numbering represents like features. Electronic display 910 may be secured to a frame 917 of aircraft galley 900. In various embodiments, electronic display 910 may be secured to a frame 917 of retention assembly 912. Electronic display 910 may be secured to frame 917 via a pair of clamps 934. Each clamp 934 may have a device-receiving region 935 shaped to conform to, grip, or frictionally engage a peripheral edge or surface of electronic display 910. An adjustable bar 936 may define a distance between clamps 934. A distance between clamps 934 may be adjustable by extending or contracting adjustable bar 936 between a minimum distance and a maximum distance, thereby accommodating electronic displays of varying dimensions. Adjustment of adjustable bar 936 may be provided by a sliding carriage, telescoping arm, rack-and-pinion mechanism, lead screw, cam track, threaded coupling, or other translation mechanism, and may include a biasing element (e.g., a compression spring, extension spring, or elastomeric member) that urges each clamp 934 toward each other in a clamping position while permitting manual expansion for insertion or removal of electronic display 910. In various embodiments, the clamps 934 are configured to apply a clamping force sufficient to retain electronic display 910 during aircraft operations, including takeoff, landing, turbulence, and maneuvering, while allowing tool-free removal by a crew member.

In various embodiments, frame 917 may include a ledge 920. Ledge 920 may have a recess 922 for receiving a bottom edge of electronic display 910. Ledge 920 and recess 922 may cooperate with clamps 934 to stabilize electronic display 910 during flight operations, thereby preventing displacement, rattling, or damage to the electronic display 910. In various embodiments, first clamp 934a is fixedly coupled to ledge 920. First clamp 934a may have a first device-receiving region 935a shaped to receive and retain a bottom edge of electronic display 910. The combination of ledge 920, recess 922, and first clamp 934a provides a stable base reference for positioning electronic display 910.

In various embodiments, second clamp 934b is adjustable with respect to ledge 920 by adjustment of adjustable bar 936. Second clamp 934b may have a second device-receiving region 935b to receive a top edge of electronic display 910.

While illustrated as having a pair of clamps 934 disposed at either end of adjustable bar 936, it should be understood that aircraft galley 900 may comprise a single clamp 934. For example, adjustable bar 936 may be directly coupled to ledge 920. In various embodiments, adjustable bar 936 may be stowable within ledge 920 such that adjustable bar 936 may be retracted within and extendable from ledge 920. In such an embodiment, it is contemplated that only second clamp 934b is coupled to adjustable bar 936. In such an embodiment, it is contemplated that second clamp 934b may be stowable within ledge 920.

In various embodiments, it is contemplated that aircraft galley 900 may comprise only first clamp 934a without a second clamp 934b. In such embodiments, first clamp 934a may secure electronic display 910 in a vertical position. In such embodiments, adjustable bar 936 may provide a vertical stop or rest for electronic display 910. However, in various embodiments, it is contemplated that adjustable bar 936 may be omitted.

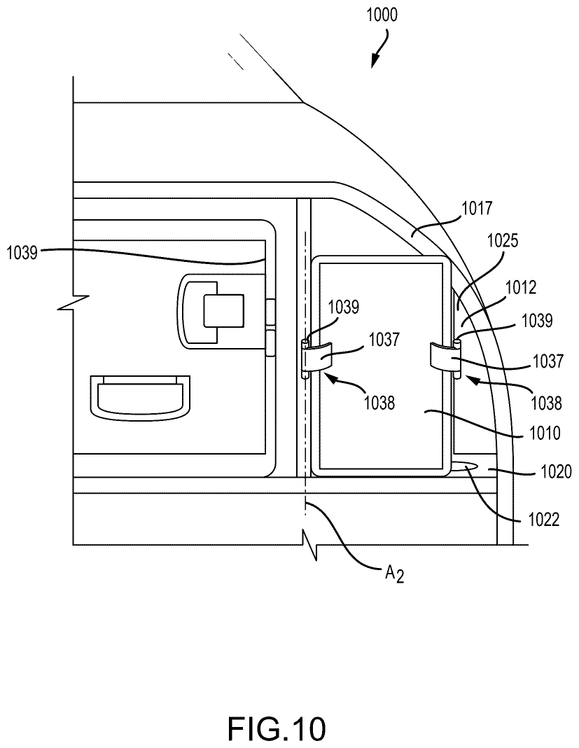

With additional reference to FIG. 10, an electronic display 1010 is illustrated in a portion of an aircraft galley 1000. Aircraft galley 1000 may be similar to aircraft galley 400 such that like numbering represents like features. Electronic display 1010 may be similar to electronic display 410 such that like numbering represents like features. Electronic display 1010 may be secured to a frame 1017 of aircraft galley 1000. In various embodiments, electronic display 1010 may be secured to a frame 1017 of retention assembly 1012. In various embodiments, electronic display 1010 may be secured directly to retention assembly 1012. Electronic display 1010 may be secured to frame 1017 via one or more clasps 1038. For example, electronic display 1010 may be secured to frame 1017 via a pair of clasps 1038 disposed on opposing sides of electronic display 1010.

In various embodiments, each clasp 1038 may include a clasp body 1037 rotatably mounted to a pivot member 1039. Each clasp body 1037 may be rotatable about a pivot axis A2. Pivot members 1039 may be pins, fasteners, hinges, or other elongate structures defining pivot axis A2. Each pivot member 1039 may be fixed to frame 1017 and/or retention assembly 1012. Clasp body 1037 may be rotatable between an engaged position and a disengaged position. In the engaged position, clasp body 1037 bears against, captures, or overlaps electronic display 1010 to inhibit relative separation of electronic display 1010 from aircraft galley 1000. In the disengaged position, clasp body 1037 is rotated about pivot axis A2 to move clasp body 1037 out of operative engagement and permit separation or relative movement of electronic display 1010 from aircraft galley 1000. In some implementations, clasp body 1037 may comprise a cam surface, hook surface, shoulder, or latch face for engaging with electronic display 1010 in the engaged position. Each clasp 1038 may further include a stop feature limiting travel, and a retention feature such as a spring bias, detent, over-center geometry, or friction element configured to maintain clasp 1038 in the engaged position and reduce inadvertent release due to vibration or handling.

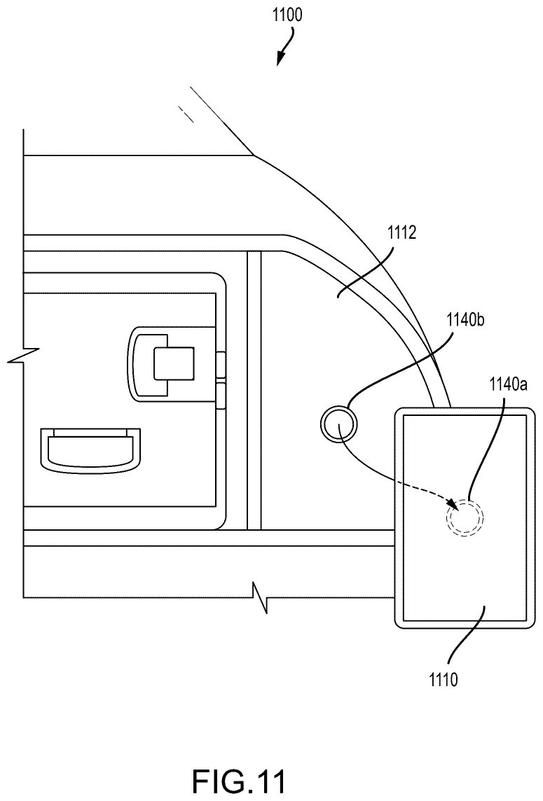

With additional reference to FIG. 11, an electronic display 1110 is illustrated in a portion of an aircraft galley 1100. Aircraft galley 1100 may be similar to aircraft galley 400 such that like numbering represents like features. Electronic display 1110 may be similar to electronic display 410 such that like numbering represents like features. Electronic display 1110 may be secured to a frame 1117 of aircraft galley 1100. In various embodiments, electronic display 1110 may be secured to a frame 1117 of retention assembly 1112. Electronic display 1110 may be secured to frame 1117 via one or more magnets 1140. For example, electronic display 1110 may comprise a first magnet 1140a disposed within electronic display 1110 while aircraft galley 1100 comprises a second magnet 1140b disposed within retention assembly 1112, frame 1117, or other structure of aircraft galley 1100. First magnet 1140a and second magnet 1140b may be of opposing polarizations such that first magnet 1140a and second magnet 1140b are attracted to each other by a force sufficient to secure electronic display 1110 to aircraft galley 1100 during aircraft operations, including during takeoff, landing, turbulence, and maneuvering. In various embodiments, the magnets 1140 may be permanent magnets, electromagnets, or a combination thereof. In various embodiments, the magnets 1140 may be rare earth magnets (e.g., neodymium or samarium-cobalt magnets) configured to provide a high retention force relative to their size. In various embodiments, retention assembly 1112 may include a ferromagnetic plate, insert, or coating configured to magnetically couple with first magnet 1140a, thereby enabling magnetic retention without requiring a corresponding second magnet 1140b in retention assembly 1112. The magnetic retention may provide silent, vibration-free attachment and tool-free, single-handed detachment of electronic display 1110.

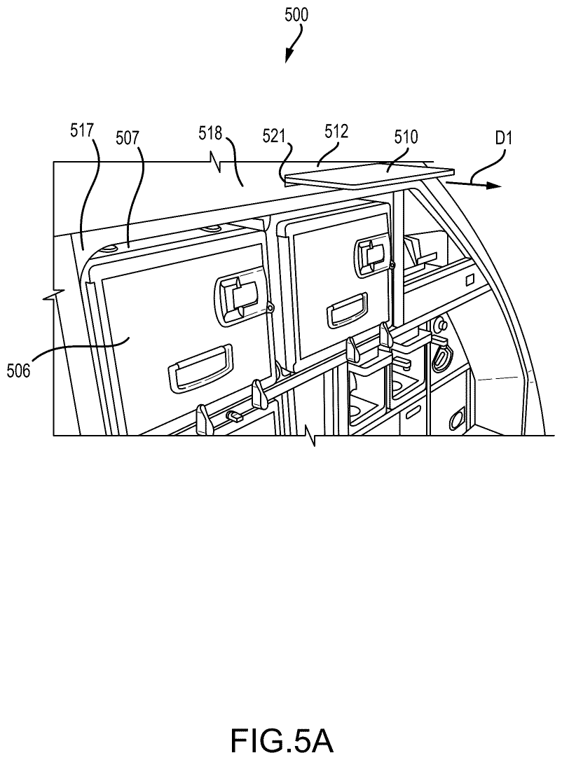

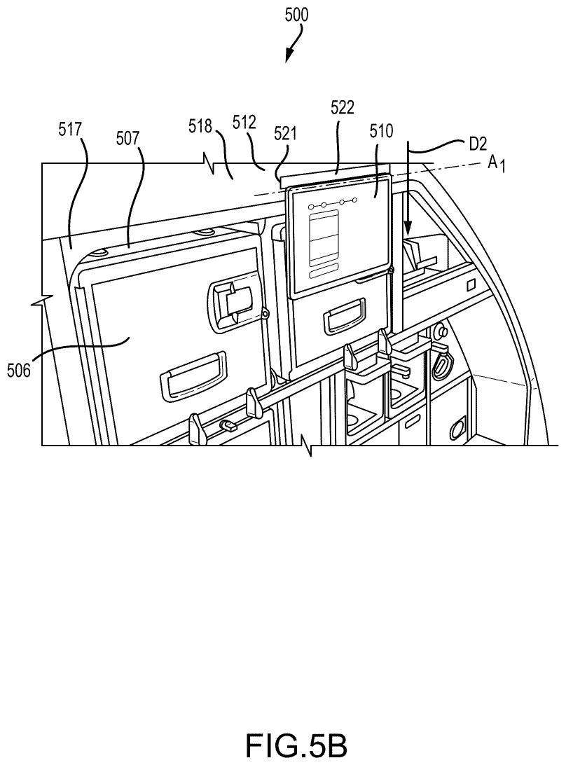

With reference to FIGS. 5A and 5B, an electronic display 510 is illustrated in a portion of an aircraft galley 500. Aircraft galley 500 may be similar to aircraft galley 100 such that like numbering represents like features. Electronic display 510 may be similar to electronic display 110 such that like numbering represents like features. In various embodiments, electronic display 510 is stowable within aircraft galley 500 such that electronic display 510 may be retracted within and extendable from aircraft galley 500. The stowable configuration enables the electronic display 510 to be concealed when not in use, thereby preserving a flush, unobstructed galley surface and maximizing available workspace for crew activities. In various embodiments, electronic display 510 is stowable within frame 517 of aircraft galley 500 such that electronic display 510 may be retracted within and extendable from frame 517. In various embodiments, electronic display 510 is stowable within retention assembly 512 of aircraft galley 500 such that electronic display 510 may be retracted within and extendable from retention assembly 512. The stowable arrangement distinguishes the electronic display 510 from conventional fixed galley features by providing an on-demand deployment capability without permanently occupying galley surface area.

In various embodiments, aircraft galley 500 comprises a slot 521 for receiving electronic display 510. In various embodiments, slot 521 may be formed into aircraft galley 500. In various embodiments, electronic display 510 is coupled to the aircraft galley 500 via a hinge 522 configured to stow within slot 521. In various embodiments, slot 521 is formed into frame 517. In various embodiments, slot 521 may be formed into retention assembly 512. In various embodiments, slot 521 may be formed into a surface panel 518. Slot 521 may be disposed horizontally into aircraft galley 500. In various embodiments, slot 521 may be a high-aspect-ratio aperture, groove, or channel formed into the aircraft galley 500 at least partially defining an opening configured to at least partially retain the electronic display 510 and hinge 522 in a stowed position. The slot 521 may be dimensioned to receive the electronic display 510 with minimal clearance, thereby reducing rattling, vibration, and noise during aircraft operations. In various embodiments and as illustrated in FIG. 5A, electronic display 510 may translate from a stowed position within aircraft galley 500 in a first direction D1 to a first deployed position. In the first deployed position, hinge 522 may at least partially extend from slot 521. In the first deployed position, electronic display 510 may be disposed perpendicular to a front face of aircraft galley 500. In various embodiments and as illustrated in FIG. 5B, electronic display 510 may rotate with respect to aircraft galley 500 about a horizontal display axis A1 of hinge 522 to a second deployed position. In the second deployed position, electronic display 510 may be disposed in a second direction D2 perpendicular to first direction D1. In the second deployed position, electronic display 510 may be disposed parallel to and proximate a front face of aircraft galley 500. In various embodiments, when in the second deployed position, electronic display 510 may be disposed in front of various galley features, such as, for example, storage compartment 507 and/or bin 506, while remaining removable or retractable to permit access to such galley features when needed.

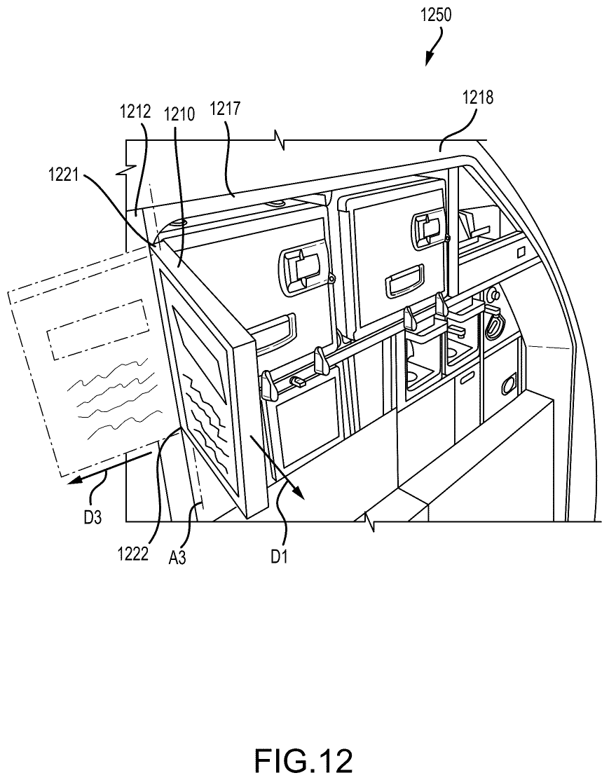

In various embodiments and with additional reference to FIG. 12, electronic display 1210 is illustrated in a third deployed position perpendicular to aircraft galley 1200. Aircraft galley 1200 may be similar to aircraft galley 500 such that like numbering represents like features. Electronic display 1210 may be similar to electronic display 510 such that like numbering represents like features. Electronic display 1210 may be stowable within a slot 1221 of aircraft galley 1200 in a stowed position. In various embodiments, electronic display 1210 is coupled to the aircraft galley 1200 via a hinge 1222 configured to stow within slot 1221. In various embodiments, slot 1221 may be a high-aspect-ratio aperture, groove, or channel formed into the aircraft galley 1200 at least partially defining an opening configured to at least partially retain the electronic display 1210 and hinge 1222. In various embodiments, slot 1221 may be formed into aircraft galley 1200. In various embodiments, slot 1221 may be formed into retention assembly 1212. In various embodiments, slot 1221 may be formed into a surface panel 1218. Slot 1221 may be disposed vertically into aircraft galley 1200.

In various embodiments, electronic display 1210 may translate from a stowed position within aircraft galley 1200 in the first direction D1 to a third deployed position. In the third deployed position, hinge 1222 may at least partially extend from slot 1221. In the third deployed position, electronic display 1210 may be disposed perpendicular to a front face of aircraft galley 1200. In various embodiments, electronic display 1210 may rotate with respect to aircraft galley 1200 about a vertical display axis A3 of hinge 1222 to a fourth deployed position. In the fourth deployed position, electronic display 1210 may be disposed in a third direction D3 perpendicular to first direction D1. In the fourth deployed position, electronic display 1210 may be disposed parallel to and proximate a front face of aircraft galley 1200. In various embodiments, when in the fourth deployed position, electronic display 1210 may be disposed in front of various galley features.

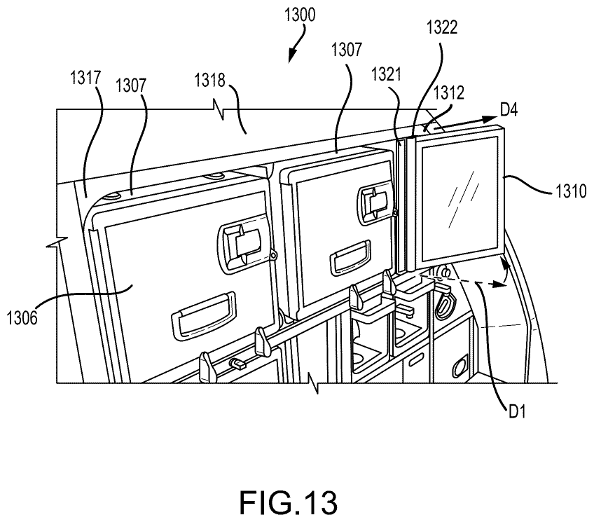

In various embodiments and with additional reference to FIG. 13, electronic display 1310 is illustrated in a fifth deployed position perpendicular to aircraft galley 1300. Aircraft galley 1300 may be similar to aircraft galleys 500, 1200 such that like numbering represents like features. Electronic display 1310 may be similar to electronic displays 510, 1210 such that like numbering represents like features. Electronic display 1310 may be stowable within a slot 1321 of aircraft galley 1300 in a stowed position. In various embodiments, electronic display 1310 is coupled to the aircraft galley 1300 via a hinge 1322 configured to stow within slot 1321. In various embodiments, slot 1321 may be a high-aspect-ratio aperture, groove, or channel formed into the aircraft galley 1300 at least partially defining an opening configured to at least partially retain the electronic display 1310 and hinge 1322. In various embodiments, slot 1321 may be formed into aircraft galley 1300. In various embodiments, slot 1321 may be formed into retention assembly 1312. In various embodiments, slot 1321 may be formed into a surface panel 1318. Slot 1321 may be disposed vertically into aircraft galley 1300. Slot 1321 may be disposed between a pair of storage compartments 1307. Slot 1321 may be disposed between a compartment 1307 and retention assembly 1312.

In various embodiments, electronic display 1310 may translate from a stowed position within aircraft galley 1300 in the first direction D1 to a fifth deployed position. In the fifth deployed position, hinge 1322 may at least partially extend from slot 1321. In the fifth deployed position, electronic display 1310 may be disposed perpendicular to a front face of aircraft galley 1300. In various embodiments, electronic display 1310 may rotate with respect to aircraft galley 1300 about a vertical display axis A4 of hinge 1322 to a sixth deployed position. In the sixth deployed position, electronic display 1310 may be disposed in a fourth direction D4 perpendicular to first direction D1. In the sixth deployed position, electronic display 1310 may be disposed parallel to and proximate a front face of aircraft galley 1300. In various embodiments, when in the sixth deployed position, electronic display 1310 may be disposed in front of various galley features.

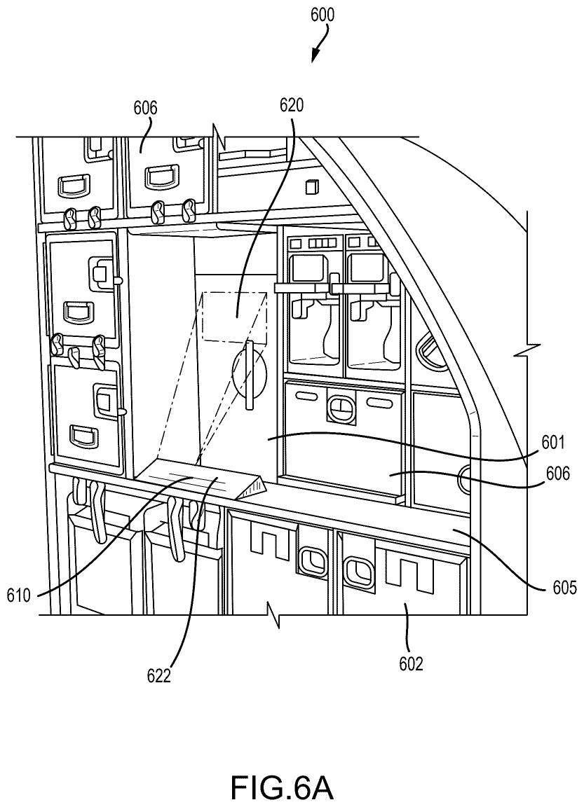

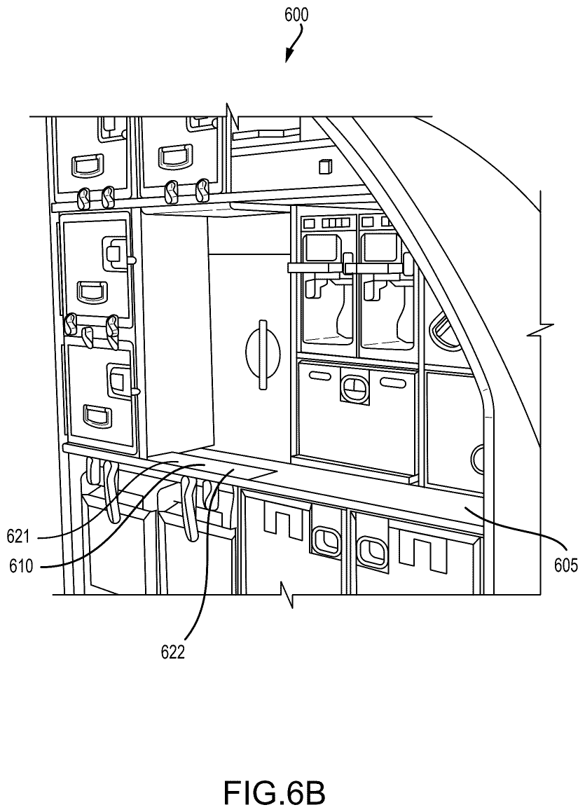

With reference to FIGS. 6A and 6B, an electronic display 610 is illustrated in a portion of an aircraft galley 600. Aircraft galley 600 may be similar to aircraft galley 100 such that like numbering represents like features. Electronic display 610 may be similar to electronic display 110 such that like numbering represents like features. In various embodiments, electronic display 610 is stowable within aircraft galley 600 such that electronic display 610 may be retracted within and extendable from aircraft galley 600. In various embodiments, electronic display 610 is stowable within counter area 605 of aircraft galley 600 such that electronic display 610 may be retracted within and extendable from a stowage cavity 621 within counter area 605. The stowable configuration enables the electronic display 610 to be concealed when not in use, thereby preserving a flush, unobstructed galley surface and maximizing available workspace for crew activities.

In various embodiments, electronic display 610 is a projector having a light oriented toward galley features of aircraft galley 600. In various embodiments, electronic display 610 projects an image 620 onto aircraft galley 600. Image 620 may contain static or dynamic content including, for example, flight status, task status, equipment status, maintenance status, emergency procedures, inventory status, etc.

In various embodiments, the image 620 may be projected onto various galley features such as include doors 601, chillers 602, ovens 604, bins 606, or any other object found in aircraft galley 600. In various embodiments, the image 620 may be projected onto aircraft galley 600.

While illustrated as deployable from a stowage cavity 621 within counter area 605 of aircraft galley 600, it is contemplated that electronic display 610 may be deployable from alternate locations such as a ceiling panel of an aircraft, another aircraft galley, or any other structure within the aircraft.

In various embodiments, electronic display 610 may have a top surface 622 which forms a portion of counter area 605 when electronic display 610 is in a stowed position. Top surface 622 may be flush with counter area 605 when electronic display 610 is in a stowed position. Electronic display 610 may be movable between a stowed position and a deployed position by manual deployment, by releasing/latching a latch, by pressing the top surface 622 to latch/release electronic display, or by any other suitable means.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An aircraft galley, comprising:
a retention assembly; and
an electronic display having a display housing and a display face, wherein the electronic display is mounted to the retention assembly in an unintrusive manner, and wherein the retention assembly is configured to retain the electronic display during aircraft operations.

2. The aircraft galley of claim 1, wherein the electronic display has at least one of a triangular shape or an irregular polygon shape.

3. The aircraft galley of claim 2, wherein the electronic display is fixedly mounted to the retention assembly proximate a storage compartment, wherein an area of the display face is less than an area of the storage compartment.

4. The aircraft galley of claim 1, wherein the electronic display is selectively mounted to the retention assembly.

5. The aircraft galley of claim 4, wherein the electronic display is selectively mounted to the retention assembly via at least one of retention cords having end fittings configured to releasably attach to anchors coupled to the retention assembly, or pivoting latches each having a catch portion configured to selectively engage the electronic display.

6. The aircraft galley of claim 4, wherein the electronic display is selectively mounted to the retention assembly via at least one clamp having a device-receiving region configured to grip a peripheral edge of the electronic display.

7. The aircraft galley of claim 6, wherein the at least one clamp is coupled to an adjustable bar.

8. The aircraft galley of claim 7, wherein the at least one clamp is one of a pair of clamps coupled to opposing ends of the adjustable bar such that the pair of clamps is biased toward each other to retain the display housing therebetween.

9. The aircraft galley of claim 4, wherein the electronic display is selectively mounted to the retention assembly via a clasp having a clasp body and a pivot member, the pivot member fixedly coupled to the retention assembly and the clasp body.

10. The aircraft galley of claim 4, wherein the electronic display is selectively mounted to the retention assembly via magnetic retention comprising a first magnet disposed within the electronic display and at least one of a second magnet or a ferromagnetic element disposed within the retention assembly, the first magnet and the at least one of the second magnet or the ferromagnetic element configured to magnetically couple and retain the electronic display to the retention assembly during aircraft operations.

11. An aircraft galley, comprising:
a retention assembly at least partially defining a frame of a galley feature; and
an electronic display mounted to the retention assembly in an unintrusive manner such that the electronic display does not obstruct or impede access to galley features of the aircraft galley, wherein the retention assembly is distinct from conventional galley features and is configured specifically to support and retain the electronic display.

12. The aircraft galley of claim 11, wherein the electronic display is configured to display at least one of a flight status, a task status, an equipment status, a maintenance status, an emergency procedure, or an inventory status on a display face of the electronic display.

13. The aircraft galley of claim 11, wherein the retention assembly comprises a slot.

14. The aircraft galley of claim 13, further comprising a hinge coupling the electronic display to the retention assembly, wherein the electronic display and the hinge are stowable within an opening of the retention assembly, the opening at least partially defined by the slot, and wherein the electronic display is configured to translate from the slot in a first direction to a first deployed position.

15. The aircraft galley of claim 14, wherein, in response to translating the electronic display to the first deployed position, the hinge at least partially extends from the slot such that the electronic display is rotatable about the hinge to a second deployed position.

16. An aircraft galley, comprising:
a retention assembly at least partially defining a frame of a galley feature; and
an electronic display stowable within the retention assembly in an unintrusive manner, wherein the retention assembly defines a stowage cavity or a slot configured to receive and conceal the electronic display when in a stowed position such that a surface of the retention assembly remains substantially flush and unobstructed.

17. The aircraft galley of claim 16, wherein the retention assembly comprises the slot.

18. The aircraft galley of claim 17, further comprising a hinge coupling the electronic display to the retention assembly, wherein the electronic display and the hinge are stowable within an opening of the retention assembly, the opening at least partially defined by the slot, and wherein, in response to translating the electronic display from the stowed position to a first deployed position, the hinge at least partially extends from the slot such that the electronic display is rotatable about the hinge to a second deployed position.

19. The aircraft galley of claim 16, wherein the retention assembly comprises a counter area, wherein a top surface of the electronic display is configured to be disposed flush with the counter area in a stowed position.

20. The aircraft galley of claim 19, wherein the electronic display is a projector.
